(19) United States
(12) Patent Application Publication
(10) Pub. No.: US 2013/0290962 A1
(43) Pub. Date: Oct. 31, 2013

(54) METHOD AND DEVICE FOR ACQUIRING A VIRTUAL FRAME NUMBER AND A VIRTUAL SLOT NUMBER

(71) Applicant: HUAWEI TECHNOLOGIES CO., LTD., Shenzhen (CN)

(72) Inventors: Shaoqiang HU, Chengdu (CN); Gaofeng Yang, Shenzhen (CN); Xiaobing Qing, Shenzhen (CN); Shouzhong Zhao, Shenzhen (CN)

(73) Assignee: Huawei Technologies Co., Ltd., Shenzhen (CN)

(21) Appl. No.: 13/930,704

(22) Filed: Jun. 28, 2013

Related U.S. Application Data
(63) Continuation of application No. PCT/CN2011/085132, filed on Dec. 31, 2011.

(30) Foreign Application Priority Data
Dec. 31, 2010 (CN) 201010624364.9

(51) Int. Cl. G06F 9/455

(52) U.S. Cl. CPC G06F 9/455
USPC 718/1

(57) ABSTRACT

A method for acquiring a virtual frame number and a virtual slot number at a virtualization platform is provided. The virtualization operating system receives a command for creating a virtual server sent from a virtualization management platform. In response to the command for creating a virtual server, the virtualization operating system creates a virtual server on a board. After creating the virtual server, the virtualization operating system sends a frame number request message carrying an identifier of the virtual server to the virtualization management platform. The virtualization operating system receives a virtual frame number corresponding to the identifier of the virtual server sent from the virtualization management platform. The virtualization operating system obtains a virtual slot number corresponding to the identifier of the virtual server according to the virtual frame number.

### CROSS-REFERENCE TO RELATED APPLICATIONS

This application is a continuation of International Application No. PCT/CN2011/085132, filed on Dec. 31, 2011, which claims priority to Chinese Patent Application No. 201010624364.9, filed on Dec. 31, 2010, both of which are hereby incorporated by reference in their entireties.

### FIELD

The present disclosure relates to the field of communications technologies, and in particular to a method and a device for acquiring a virtual frame number and a slot number at a virtualization platform.

### BACKGROUND

Advanced telecom computing architecture (ATCA) is a cost-efficient compatible and extensible hardware architecture that is based on a modular structure and is provided for next-generation convergence communications and data network applications.

In a communications system based on the ATCA architecture, a frame number and a slot number are widely used to identify board information. For example, a board control plane Internet Protocol (IP) address is automatically generated, board alarm maintenance information is generated, and faults are located according to the frame number and the slot number.

The virtualization technology may be used to generate multiple virtual servers on one ATCA board through virtualization. These virtual servers may run service programs different from those run on the physical board in a non-virtualization environment. In the virtualization environment, however, all the virtual servers on an ATCA board acquire the same frame number and slot number of a physical board. As such, the frame number and the slot number acquired in the ATCA architecture-based communications system are the same, thereby failing to meet the requirement that services are migrated to the virtualization platform.

### SUMMARY

An embodiment of the present invention provides a method for acquiring a virtual frame number and a virtual slot number at a virtualization platform. A method for acquiring a virtual frame number and a virtual slot number at a virtualization platform is provided. The virtualization operating system receives a command for creating a virtual server sent from a virtualization management platform. In response to the command for creating a virtual server, the virtualization operating system creates a virtual server on a board. After creating the virtual server, the virtualization operating system sends a frame number request message carrying an identifier of the virtual server to the virtualization management platform. The virtualization operating system receives a virtual frame number corresponding to the identifier of the virtual server sent from the virtualization management platform. The virtualization operating system obtains a virtual slot number corresponding to the identifier of the virtual server according to the virtual frame number.

Another embodiment of the present invention provides a method for acquiring a virtual frame number and a virtual slot number at a virtualization platform. The virtualization management platform sends a command for creating a virtual server on a board to a virtualization operating system. The virtualization management platform receives a response to the command for creating a virtual server from the virtualization operating system. The virtualization management platform obtains a virtual frame number and a virtual slot number which are corresponding to an identifier of the virtual server created by the virtualization operating system. The virtualization management platform receives a request message for acquiring a virtual frame number and a virtual slot number that carries the identifier of the virtual server. The virtualization management platform sends the virtual frame number and virtual slot number to the virtual server via the virtualization operating system.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and persons of ordinary skill in the art can derive other drawings from the accompanying drawings without creative efforts.

FIG. 1 is a flow chart of a method for acquiring a virtual frame number and a slot virtual number at a virtualization platform according to an embodiment of the present invention;

FIG. 2 is a flow chart of a method for acquiring a virtual frame number and a slot virtual number at a virtualization platform according to another embodiment of the present invention;

FIG. 3 is a schematic diagram of an example procedure for deleting a virtual server;

FIG. 4 is a flow chart of a method for acquiring a virtual frame number and a virtual slot number at a virtualization platform according to still another embodiment of the present invention;

FIG. 5 is a schematic diagram of another example procedure for deleting a virtual server;

FIG. 6 is a schematic structural diagram of a virtualization operating system entity device according to an embodiment of the present invention;

FIG. 7 is a schematic structural diagram of a virtualization operating system entity device according to another embodiment of the present invention;

FIG. 8 is a schematic structural diagram of a virtualization management platform device according to an embodiment of the present invention; and

FIG. 9 is a schematic structural diagram of a virtualization management platform device according to another embodiment of the present invention.

### DETAILED DESCRIPTION OF THE EMBODIMENTS

To make the objectives, technical solutions, and advantages according to the embodiments of the present invention more comprehensible, the following clearly and completely describes the technical solutions according to the embodiments of the present invention with reference to the accompanying drawings in the embodiments of the present invention. Apparently, the embodiments in the following description are merely a part rather than all of the embodiments of the present invention. All other embodiments obtained by persons of ordinary skill in the art based on the embodiments of the present invention without creative effects shall fall within the protection scope of the present invention.

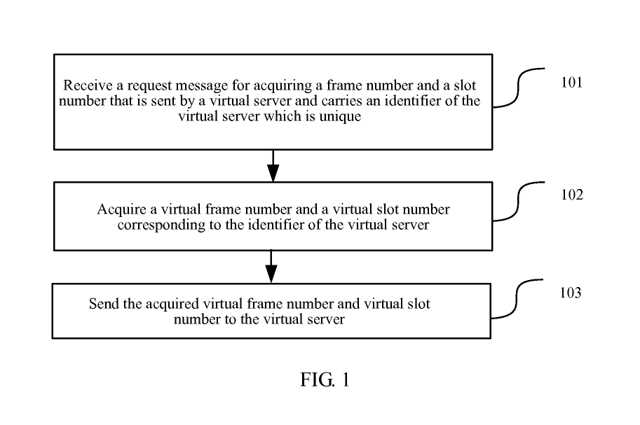

FIG. 1 is a flow chart of a method for acquiring a virtual frame number and a virtual slot number at a virtualization platform according to an embodiment of the present invention. As shown in FIG. 1, the method may include:

Step 101: receiving a request message for acquiring a frame number and a slot number, that is sent by a virtual server and carries an identifier of the virtual server. The identifier of the virtual server is unique.

Step 102: acquiring a virtual frame number and a virtual slot number corresponding to the identifier of the virtual server.

Step 103: sending the acquired virtual frame number and virtual slot number to the virtual server.

In an implementation mode according to this embodiment, before receiving the request message, a virtualization operating system (i.e., Hypervisor) may create the virtual server according to a command for creating a virtual server sent by a virtualization management platform, and then send a frame number request message that carries the identifier of the virtual server to the virtualization management platform. The virtualization operating system may receive the virtual frame number corresponding to the identifier of the virtual server sent by the virtualization management platform, generate the virtual slot number corresponding to the identifier of the virtual server according to the virtual frame number, and save the virtual frame number and virtual slot number corresponding to the identifier of the virtual server to a table entry in a configuration file. The table entry corresponds to the identifier of the virtual server. The virtual frame number corresponding to the identifier of the virtual server is generated by the virtualization management platform according to a physical frame number of a physical frame where the virtual server is located after determining the physical frame number.

Specifically, in this implementation mode, the step of acquiring the virtual frame number and virtual slot number corresponding to the identifier of the virtual server may be as follows: the virtualization operating system searches the configuration file according to the identifier of the virtual server, and acquires the virtual frame number and virtual slot number corresponding to the identifier of the virtual server.

In addition, in this implementation mode, after receiving a command for deleting a virtual server that is sent by the virtualization management platform and carries the identifier of the virtual server, the virtualization operating system may delete the virtual server according to the identifier of the virtual server. The virtualization operating system deletes the table entry corresponding to the identifier of the virtual server from the configuration file, and reclaims the virtual frame number and virtual slot number corresponding to the identifier of the virtual server (e.g., a garbage collection in JAVA).

In this way, when the virtualization operating system generates the virtual slot number corresponding to the identifier of the virtual server according to the virtual frame number sent by the virtualization management platform, if a reclaimed virtual slot number corresponding to the virtual frame number exists, the virtualization operating system may preferably allocates the reclaimed virtual slot number to the virtual server and establishes a corresponding relationship between the virtual frame number and reclaimed virtual slot number and the identifier of the virtual server; if a reclaimed virtual slot number corresponding to the virtual frame number does not exist, the virtualization operating system may generate a virtual slot number corresponding to the identifier of the virtual server according to the virtual frame number.

In another implementation mode according to this embodiment, the step of receiving the request message for acquiring a frame number and a slot number may be as follows: the virtualization management platform receives the request message for acquiring a frame number and slot number forwarded by the virtualization operating system.

The step of sending the acquired virtual frame number and virtual slot number to the virtual server may be as follows: the virtualization management platform forwards the acquired virtual frame number and the virtual slot number to the virtual server via the virtualization operating system.

In this implementation mode, before receiving the request message for acquiring a frame number and a slot number, the virtualization management platform may receive a response sent by the virtualization operating system which responds to the command for creating a virtual server sent by the virtualization management platform, and then the virtualization management platform generates and saves the virtual frame number and virtual slot number corresponding to the identifier of the virtual server.

In this way, the virtualization management platform may search saved virtual frame numbers and virtual slot numbers to acquire the virtual frame number and virtual slot number corresponding to the identifier of the virtual server.

Further, in this implementation mode, the virtualization management platform may send a command for deleting a virtual server that carries the identifier of the virtual server to the virtualization operating system, so that the virtualization operating system deletes the virtual server according to the identifier of the virtual server. Then, the virtualization management platform may delete the virtual frame number and virtual slot number corresponding to the identifier of the deleted virtual server, and reclaims the virtual frame number and virtual slot number corresponding to the identifier of the deleted virtual server. In this way, when the virtualization management platform generates and saves the virtual frame number and virtual slot number corresponding to the identifier of the virtual server, if a reclaimed virtual frame number and virtual slot number are available, the virtualization management platform may preferably allocate the reclaimed virtual frame number and virtual slot number to the created virtual server, and establish and save a corresponding relationship between the reclaimed virtual frame number and virtual slot number and the identifier of the virtual server; if no reclaimed virtual frame number and virtual slot number are available, the virtualization management platform may generate and save the virtual frame number and virtual slot number corresponding to the identifier of the virtual server.

According to this embodiment, after receiving the request message for acquiring a frame number and slot number, the virtualization operating system or virtualization management platform acquires the virtual frame number and the virtual slot number corresponding to the identifier of the virtual server, and then sends the acquired virtual frame number and virtual slot number to the virtual server. As the identifier of the virtual server is unique, the virtual frame number and virtual slot number corresponding to the identifier of the virtual server are unique too, thus a case where the virtual frame number and virtual slot number corresponding to each virtual server are the same will not exist. In this way, each virtual server on a board may acquire a different virtual frame number and a different virtual slot number, so that services on the board may be transparently migrated to the virtualization platform.

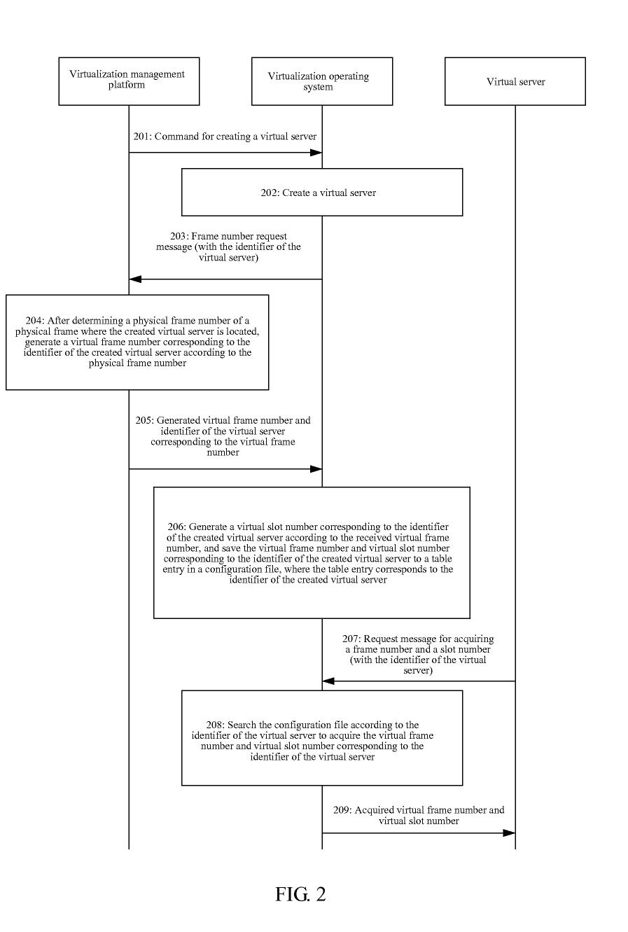

FIG. 2 is a flow chart of a method for acquiring a virtual frame number and a slot number at a virtualization platform according to another embodiment of the present invention. As shown in FIG. 2, the method may include:

Step 201: a virtualization operating system receives a command for creating a virtual server sent by a virtualization management platform.

Step 202: the virtualization operating system creates a virtual server.

Specifically, after receiving the command for creating a virtual server, the virtualization operating system creates a virtual server according to the command for creating a virtual server.

Step 203: the virtualization operating system sends a frame number request message to the virtualization management platform. The frame number request message carries an identifier (ID) of the virtual server, and the ID of the virtual server is unique.

Step 204: after determining a physical frame number of a physical frame where the virtual server is located, the virtualization management platform generates a virtual frame number corresponding to the identifier of the virtual server according to the physical frame number.

Specifically, in this embodiment, the virtual frame number may range from 0 to 65535. The virtualization management platform generates the virtual frame number according to the physical frame number of the physical board where the created virtual server is located. The virtual frame number may be the same as or different from the physical frame number. The virtual frame number, however, must be in a one-to-one corresponding relationship with the physical frame number, and the virtual frame number is unique at one virtualization management platform.

Step 205: the virtualization management platform sends the virtual frame number and the identifier of the virtual server corresponding to the virtual frame number to the virtualization operating system.

Step 206: the virtualization operating system generates a virtual slot number corresponding to the identifier of the virtual server according to the received virtual frame number, and saves the virtual frame number and virtual slot number corresponding to the identifier of the virtual server to a table entry in a configuration file. The table entry corresponds to the identifier of the virtual server.

Specifically, in this embodiment, the virtual slot number may range from 0 to 20, and at least one virtual slot number under each virtual frame number may be set as unavailable. For example, virtual slot numbers 7 and 8 under each virtual frame number may be set as unavailable. Certainly, the virtual slot numbers that are unavailable under each virtual frame number may be set at random.

After the virtual slot number corresponding to the identifier of the virtual server is generated, the virtualization operating system saves the virtual frame number and virtual slot number corresponding to the identifier of the virtual server into the table entry corresponding to the identifier of the virtual server in the configuration file. If no configuration file exists in the virtualization operating system, a configuration file needs to be generated before the virtual frame number and virtual slot number are saved.

The configuration file at least needs to include a virtual server identifier field, a virtual frame number field, and a virtual slot number field. The identifier of each virtual server is unique, and the virtual frame number and virtual slot number of each virtual server may be combined to uniquely indicate the virtual server.

The configuration file in this embodiment may be a file in an extensible markup language (XML) format. Certainly, the configuration file may be a file in other formats, which is not limited by the embodiments of the present invention.

Step 207: the virtualization operating system receives a request message for acquiring a frame number and a slot number that is sent by the virtual server, where the request message for acquiring a frame number and a slot number carries the identifier of the virtual server.

Step 208: the virtualization operating system searches the configuration file according to the identifier of the virtual server to acquire the virtual frame number and virtual slot number corresponding to the identifier of the virtual server.

Step 209: the virtualization operating system sends the acquired virtual frame number and virtual slot number to the virtual server.

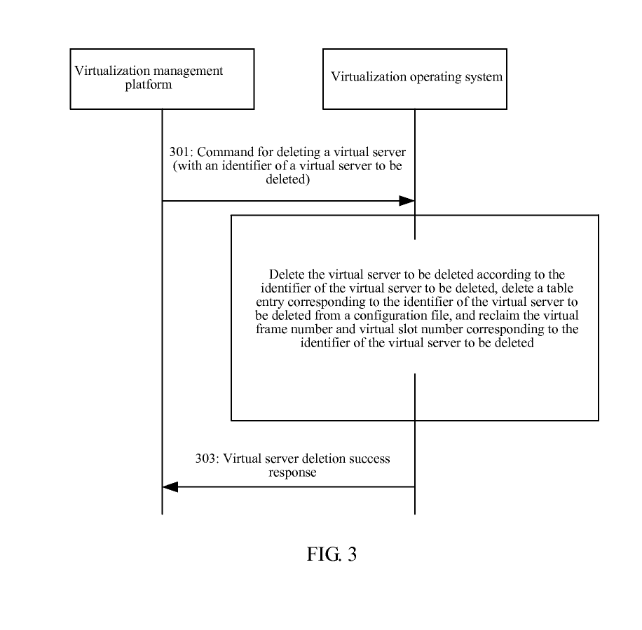

In this embodiment, the procedure for deleting a virtual server is shown in FIG. 3. FIG. 3 is a schematic diagram of a procedure for deleting a virtual server according to an embodiment of the present invention, this procedure may include:

Step 301: the virtualization management platform sends a command for deleting a virtual server to the virtualization operating system. The command for deleting a virtual server carries an identifier of the virtual server to be deleted.

Step 302: After receiving the command for deleting a virtual server, the virtualization operating system may delete the virtual server according to the identifier of the virtual server, deletes the table entry corresponding to the identifier of the virtual server from the configuration file, reclaims the virtual frame number and virtual slot number corresponding to the identifier of the virtual server, and preferably allocates the reclaimed virtual slot number to a created virtual server when generating a virtual slot number for the virtual server after creating the virtual server next time.

Step 303: the virtualization operating system sends a virtual server deletion success response to the virtualization management platform.

In step 206, when the virtualization operating system generates the virtual slot number corresponding to the virtual server according to the received virtual frame number, if a reclaimed virtual slot number corresponding to the virtual frame number exists, the virtualization operating system may preferably allocates the reclaimed virtual slot number to the virtual server and establishes a corresponding relationship between the virtual frame number and reclaimed virtual slot number and the identifier of the created virtual server; if a reclaimed virtual slot number corresponding to the virtual frame number does not exist, the virtualization operating system may generate a virtual slot number corresponding to the identifier of the virtual server according to the virtual frame number. In other words, after the virtual server is created, and the virtualization management platform sends the virtual frame number corresponding to the identifier of the virtual server to the virtualization operating system, the virtualization operating system may first judge whether a reclaimed virtual slot number corresponding to the virtual frame number exists; if yes, the virtualization operating system allocates the reclaimed virtual slot number for the virtual server; if no, the virtualization operating system generates a new virtual slot number for the virtual server.

Certainly, the preceding is merely an example of this embodiment, but does not limit the embodiment. The virtualization operating system may also generate a virtual slot number corresponding to the identifier of the virtual server preferably according to the received virtual frame number. After unused virtual slot numbers corresponding to the virtual frame number are used up, the virtualization operating system allocates a reclaimed virtual slot number corresponding to the virtual frame number to the virtual server. This embodiment does not restrict the manner for generating the virtual slot number by the virtualization operating system as long as the generated virtual slot number and the virtual frame number sent by the virtualization management platform may be combined to uniquely indicate the virtual server.

In addition, in this embodiment, the virtualization management platform may not consider the physical frame number of the physical frame where the virtual server is located when generating a virtual frame number for the virtual server, but generates a virtual frame number for the virtual server according to a rule configured in advance. This embodiment does not limit the manner for generating a virtual frame number for the virtual server, as long as the generated virtual frame number is unique at one virtualization management platform.

According to this embodiment, after receiving a request message for acquiring a frame number and a slot number, the virtualization operating system acquires the virtual frame number and the virtual slot number corresponding to the identifier of the virtual server, and then sends the acquired virtual frame number and virtual slot number to the virtual server. As the identifier of the virtual server is unique, the virtual frame number and virtual slot number corresponding to the identifier of the virtual server are unique too, thus a case where the virtual frame number and virtual slot number corresponding to each virtual server are the same will not exist. In this way, each virtual server on a board may acquire a different virtual frame number and a different virtual slot number. The technology for virtual frame number and slot number provided in this embodiment simplifies the complicated procedure for acquiring physical frame number and slot number. In addition, a frame and slot number service is involved in an application in an ATCA/advanced telecom application environment (ATAE) frame management mode. For example, when the control plane IP address and services, such as alarm and fault maintenance, are migrated to the virtualization platform, the virtual frame number and slot number do not need to be modified. In addition, the virtual frame and slot number are generated for the virtual servers on the board as required. In this way, applications that are based on the ATCA/ATAE frame management mode are transparently migrated to the virtualization platform.

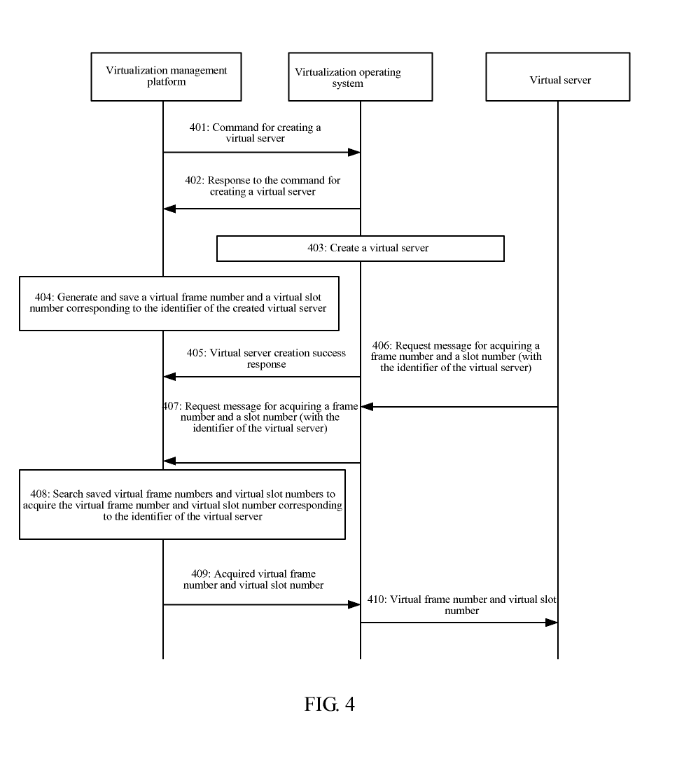

FIG. 4 is a flow chart of a method for acquiring a virtual frame number and a slot number at a virtualization platform according to still another embodiment of the present invention. As shown in FIG. 4, the method may include:

Step 401: a virtualization management platform sends a command for creating a virtual server to a virtualization operating system.

Step 402: the virtualization management platform receives a response to the command for creating a virtual server from the virtualization operating system.

Step 403: the virtualization operating system creates a virtual server.

Step 404: the virtualization management platform generates and saves a virtual frame number and a virtual slot number corresponding to an identifier of the created virtual server.

Specifically, the virtualization management platform may save the virtual frame number and virtual slot number corresponding to the identifier of the created virtual server at a database or datasheet, which is not limited by this embodiment.

In this embodiment, the sequences of step 403 and step 404 are not restricted. Step 403 and step 404 may be executed in sequence or at the same time.

Step 405: the virtualization operating system sends a virtual server creation success response to the virtualization management platform.

Step 406: the virtualization operating system receives a request message for acquiring a frame number and a slot number that is sent by the virtual server, where the request message for acquiring a frame number and a slot number carries an identifier of the virtual server. The identifier of the virtual server is unique.

Step 407: the virtualization operating system forwards the request message for acquiring a frame number and a slot number to the virtualization management platform. The request message for acquiring a frame number and a slot number carries the identifier of the virtual server. The identifier of the virtual server is unique.

Step 408: the virtualization management platform searches saved virtual frame numbers and virtual slot numbers to acquire the virtual frame number and virtual slot number corresponding to the identifier of the virtual server.

Step 409: the virtualization management platform sends the acquired virtual frame number and virtual slot number to the virtualization operating system.

Step 410: the virtualization operating system forwards the acquired virtual frame number and virtual slot number to the virtual server.

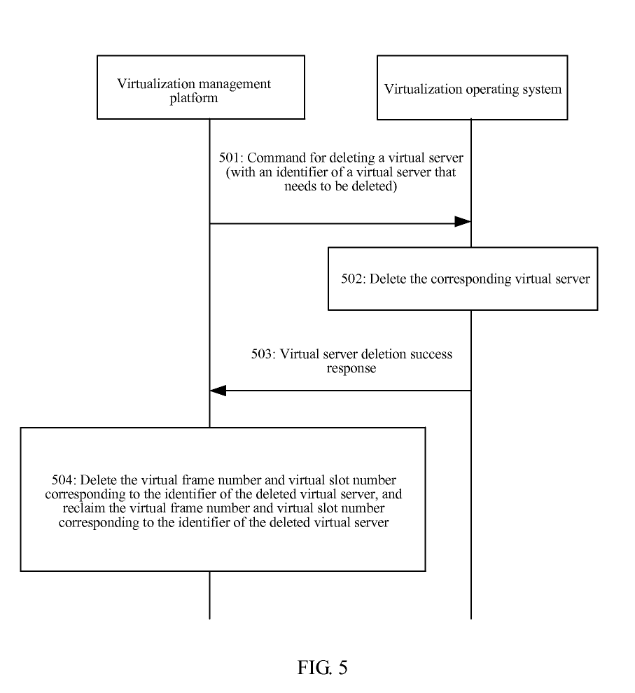

In this embodiment, a procedure for deleting a virtual server is shown in FIG. 5. FIG. 5 is a schematic diagram of another procedure for deleting a virtual server according to the present invention, which may include:

Step 501: the virtualization management platform sends a command for deleting a virtual server to the virtualization operating system. The command for deleting a virtual server carries an identifier of the virtual server that needs to be deleted.

Step 502: after receiving the command for deleting a virtual server, the virtualization operating system deletes the corresponding virtual server.

Step 503: the virtualization operating system sends a virtual server deletion success response to the virtualization management platform.

Step 504: after receiving the virtual server deletion success response, the virtualization management platform deletes the virtual frame number and virtual slot number corresponding to the identifier of the deleted virtual server, reclaim the virtual frame number and virtual slot number corresponding to the identifier of the virtual server, and preferably allocates the reclaimed virtual frame number and virtual slot number to the a created virtual server during a procedure for creating the virtual server next time.

In this way, in step 403, when the virtualization management platform generates and saves the virtual frame number and virtual slot number corresponding to the identifier of the created virtual server, if a reclaimed virtual frame number and virtual slot number are available, the virtualization management platform may preferably allocate the reclaimed virtual frame number and virtual slot number to the created virtual server, and establish and save a corresponding relationship between the reclaimed virtual frame number and virtual slot number and the identifier of the created virtual server; if no reclaimed virtual frame number and virtual slot number are available, the virtualization management platform generates and saves the virtual frame number and virtual slot number corresponding to the identifier of the created virtual server.

In this embodiment, the virtual frame number may range from 0 to 65535, and the virtual slot number may range from 0 to 20. The virtual frame number and virtual slot number may be combined to uniquely indicate a virtual server. At least one virtual slot number under each virtual frame number may be set as unavailable. For example, virtual slot numbers 7 and 8 under each virtual frame number may be set as unavailable. Certainly, the virtual slot numbers that are unavailable under each virtual frame number may be set at random.

When generating the virtual frame number and virtual slot number, the virtualization management platform may, after the virtual slot number reaches 20, add 1 to generate a new virtual frame number and virtual slot number. As an example, assuming that the virtual frame number for 20 virtual servers is 0000, the virtual slot numbers of the 20 virtual servers are 00 to 19 in sequence, the virtual frame number and virtual slot numbers of the 20 virtual servers are 000000 to 000019 in combination. In this case, if a virtual frame number and a virtual slot number need to be allocated to a newly created virtual server, 1 may be added on the basis of 019. That is, the virtual frame number and virtual slot number allocated by the virtualization management platform for the newly created virtual server may be 000100 in combination. The rest is deduced through analogy. New virtual frame numbers and virtual slot numbers are generated by adding 1. The preceding is merely an example of this embodiment. This embodiment does not restrict the method for generating virtual frame numbers and virtual slot numbers by the virtualization management platform as long as a generated virtual frame number and a virtual slot number may be combined to uniquely indicate one virtual server.

According to this embodiment, after receiving the request message for acquiring a frame number and a slot number, the virtualization management platform acquires the virtual frame number and the virtual slot number corresponding to the identifier of the virtual server, and then sends the acquired virtual frame number and virtual slot number to the virtual server via the virtualization operating system. As the identifier of the virtual server is unique, the virtual frame number and virtual slot number corresponding to the identifier of the virtual server are unique too. Thus a case where the virtual frame number and virtual slot number corresponding to each virtual server are the same will not exist. In this way, each virtual server on a board may acquire a different virtual frame number and a different virtual slot number. The technology for virtual frame number and slot number provided in this embodiment simplifies the complicated procedure for acquiring physical frame and slot numbers. In addition, a frame and slot number service is involved in an application in an ATCA/ATAE frame management mode. For example, when the control plane IP address and services such as alarm and fault maintenance are migrated to the virtualization platform, virtual frame number and slot number do not need to be modified. In addition, virtual frame number and slot number are generated for the virtual servers on the board as required. In this way, applications that are based on the ATCA/ATAE frame management mode are transparently migrated to the virtualization platform.

Persons of ordinary skill in the art should understand that all or part of the steps of the methods in the embodiments may be implemented by a program instructing relevant hardware. The program may be stored in a computer readable storage medium. When the program runs, the above steps of the method in the embodiment are performed. The storage medium may be any medium capable of storing program codes, such as ROM, RAM, magnetic disk, or optical disk, and the like.

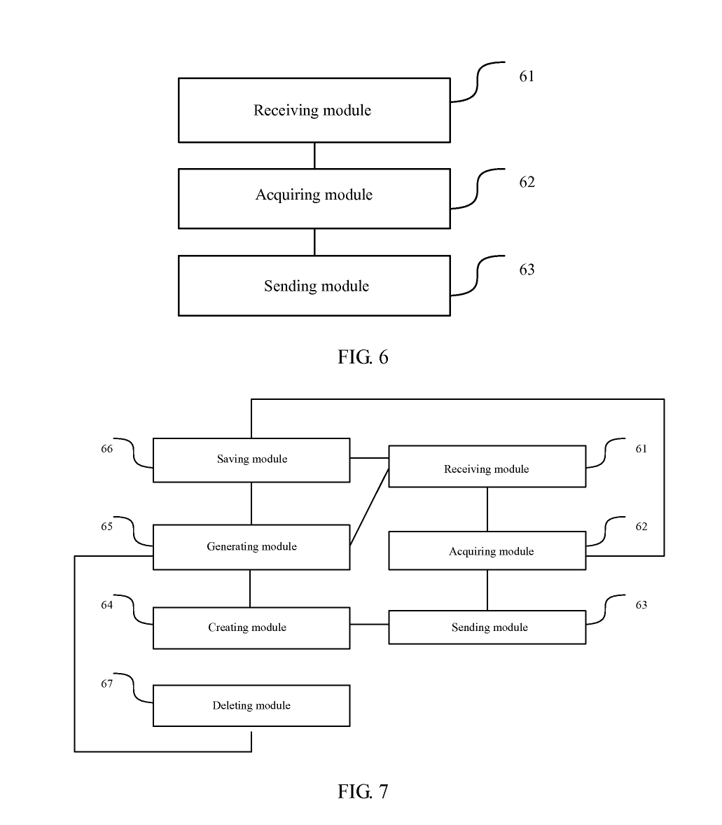

FIG. 6 is a schematic structural diagram of a virtualization operating system entity device according to an embodiment of the present invention. The virtualization operating system entity device in this embodiment may implement the procedure in the embodiment as shown in FIG. 1.

As shown in FIG. 6, the virtualization operating system entity device may include:

a receiving module 61, configured to receive a request message for acquiring a frame number and a slot number that is sent by a virtual server and carries an identifier of the virtual server. Where the identifier of the virtual server is unique;

an acquiring module 62, configured to acquire a virtual frame number and a virtual slot number corresponding to the identifier of the virtual server; and

a sending module 63, configured to send the acquired virtual frame number and virtual slot number to the virtual server.

According to the virtualization operating system entity device in this embodiment, after the receiving module 61 receives the request message for acquiring a frame number and a slot number, the acquiring module 62 acquires the virtual frame number and the virtual slot number corresponding to the identifier of the virtual server, and then the sending module 63 sends the acquired virtual frame number and virtual slot number to the virtual server. As the identifier of the virtual server is unique, the virtual frame number and virtual slot number corresponding to the identifier of the virtual server are unique too. Thus a case where the virtual frame number and virtual slot number corresponding to each virtual server are the same will not exist. In this way, each virtual server on a board may acquire a different virtual frame number and a different virtual slot number, so that services on the board may be transparently migrated to the virtualization platform.

FIG. 7 is a schematic structural diagram of a virtualization operating system entity device according to another embodiment of the present invention. The virtualization operating system entity device in this embodiment may implement the procedures in the embodiments as shown in FIG. 1 and FIG. 2.

Compared with the virtualization operating system entity device as shown in FIG. 6, the difference is as follows: the virtualization operating system entity device as shown in FIG. 7 may further include a creating module 64 and a generating module 65.

The creating module 64 is configured to create a virtual server according to a command for creating a virtual server sent by the virtualization management platform.

In this case, the sending module 63 may further send a frame number request message that carries the identifier of the created virtual server to the virtualization management platform after the creating module 64 creates the virtual server; the receiving module 61 may further receive a virtual frame number corresponding to the identifier of the created virtual server sent by the virtualization management platform.

The generating module 65 is configured to generate a virtual slot number corresponding to the identifier of the created virtual server according to the virtual frame number received by the receiving module 61.

Further, in this embodiment, the virtualization operating system entity device may further include: a saving module 66, configured to save the virtual frame number received by the receiving module 61 and the virtual slot number generated by the generating module 65 in a table entry of a configuration file. The table entry corresponds to the identifier of the created virtual server. In this way, the acquiring module 62 may search the configuration file according to the identifier of the virtual server to acquire the virtual frame number and virtual slot number corresponding to the identifier of the virtual server.

In this embodiment, the virtualization operating system entity device may further include: a deleting module 67, configured to: after the receiving module 61 receives a command for deleting a virtual server, delete the virtual server to be deleted according to the identifier of the virtual server to be deleted, delete the table entry corresponding to the identifier of the virtual server to be deleted from the configuration file, and reclaim the virtual frame number and virtual slot number corresponding to the identifier of the virtual server to be deleted. In this case, the generating module 65 may, when a reclaimed virtual slot number corresponding to the virtual frame number received by the receiving module 61 exists, preferably allocate the reclaimed virtual slot number to the created virtual server and establish a corresponding relationship between the virtual frame number received by the receiving module 61, reclaimed virtual slot number, and identifier of the created virtual server. When a reclaimed virtual slot number corresponding to the virtual frame number received by the receiving module 61 does not exist, the generating module 65 may generate a virtual slot number corresponding to the identifier of the created virtual server according to the virtual frame number received by the receiving module 61.

According to the virtualization operating system entity device, each virtual server on a board may acquire a different virtual frame number and a different virtual slot number, so as to simplify the complicated procedure for acquiring physical frame number and slot number. In addition, a frame and slot number service is involved in an application in an ATCA/advanced telecom application environment (ATAE) frame management mode. For example, when the control plane IP address and services, such as alarm and fault maintenance on a board, are migrated to the virtualization platform, virtual frame number and slot number do not need to be modified. In addition, virtual frame number and slot number are generated for the virtual servers on the board as required. In this way, applications that are based on the ATCA/ATAE frame management mode are transparently migrated to the virtualization platform.

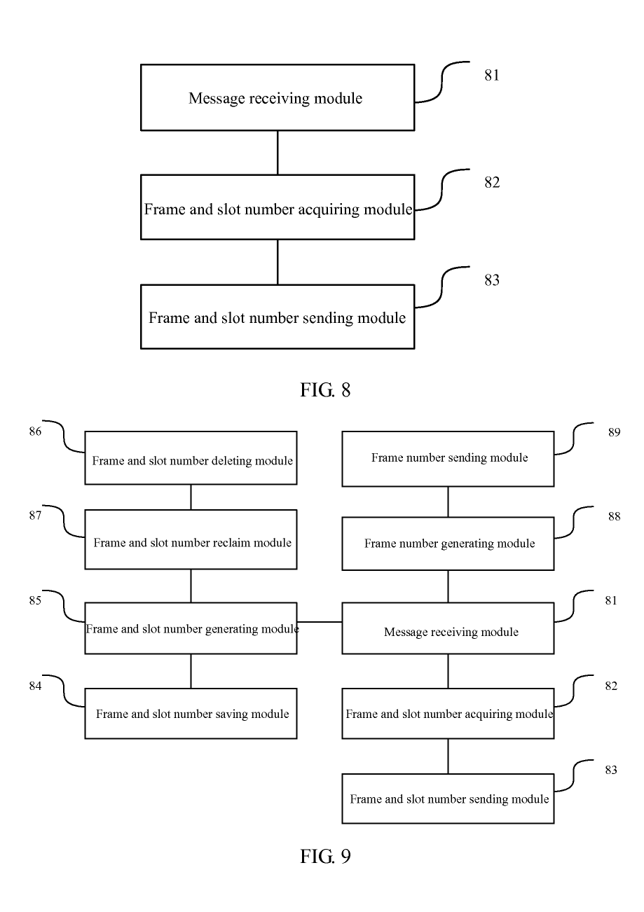

FIG. 8 is a schematic structural diagram of a virtualization management platform device according to an embodiment of the present invention. The virtualization management platform device in this embodiment may implement the procedure in the embodiment as shown in FIG. 1.

As shown in FIG. 8, the virtualization management platform device may include: a message receiving module 81, a frame and slot number acquiring module 82, and a frame and slot number sending module 83.

The message receiving module 81 is configured to receive a request message for acquiring a frame number and a slot number that is forwarded by a virtual server via a virtualization operating system and carries an identifier of the virtual server. Where the identifier of the virtual server is unique.

The frame and slot number acquiring module 82 is configured to acquire a virtual frame number and a virtual slot number corresponding to the identifier of the virtual server.

The frame and slot number sending module 83 is configured to forward the acquired virtual frame number and virtual slot number to the virtual server through the virtualization operating system.

According to this embodiment, after the message receiving module 81 receives a request message for acquiring a frame number and a slot number, the frame and slot number acquiring module 82 acquires the virtual frame number and the virtual slot number corresponding to the identifier of the virtual server, and then the frame and slot number sending module 83 sends the acquired virtual frame number and virtual slot number to the virtual server. As the identifier of the virtual server is unique, the virtual frame number and virtual slot number corresponding to the identifier of the virtual server are unique too. Thus a case where the virtual frame number and virtual slot number corresponding to each virtual server are the same will not exist. In this way, each virtual server on a board may acquire a different virtual frame number and a different virtual slot number, so that services on the board may be transparently migrated to the virtualization platform.

FIG. 9 is a schematic structural diagram of a virtualization management platform device according to another embodiment of the present invention. The virtualization management platform device in this embodiment may implement the procedures in the embodiments as shown in FIG. 1 and FIG. 4.

Compared with the virtualization management platform device as shown in FIG. 8, the difference is as follows: the virtualization management platform device as shown in FIG. 9 may further include a frame and slot number saving module 84 and a frame and slot number generating module 85.

In this embodiment, the message receiving module 81 may further receive a response (which is sent by the virtualization operating system) of a command for creating a virtual server (which is sent by the virtualization management platform). The frame and slot number generating module 85 may generate a virtual frame number and a virtual slot number corresponding to the identifier of the created virtual server after the message receiving module 81 receives the response of the command for creating a virtual server. The frame and slot number saving module 84 is configured to save the virtual frame number and virtual slot number generated by the frame and slot number generating module 85.

In this way, in order to acquire the virtual frame number and virtual slot number of the virtual server subsequently, the frame and slot number acquiring module 82 may search virtual frame numbers and virtual slot numbers saved by the frame and slot number saving module 84 to acquire the virtual frame number and virtual slot number corresponding to the identifier of the virtual server.

The virtualization management platform device in this embodiment may further include:

a frame and slot number deleting module 86, configured to: after the virtualization operating system deletes the virtual server, delete the virtual frame number and the virtual slot number corresponding to the identifier of the deleted virtual server; and

a frame and slot number reclaim module 87, configured to reclaim the virtual frame number and virtual slot number corresponding to the identifier of the deleted virtual server.

In this way, if a reclaimed virtual frame number and virtual slot number are available, the frame and slot number generating module 85 may preferably allocate the reclaimed virtual frame number and virtual slot number to the created virtual server, and establish and save a corresponding relationship between the reclaimed virtual frame number and virtual slot number and the identifier of the created virtual server; if no reclaimed virtual frame number and virtual slot number are available, the frame and slot number acquiring module 82 may generate and save a virtual frame number and a virtual slot number corresponding to the identifier of the created virtual server.

In addition, in this embodiment, the virtualization management platform device as shown in FIG. 9 may further include: a frame number generating module 88 and a frame number sending module 89.

Specifically, the message receiving module 81 may further receive a frame number request message that carries the identifier of the created virtual server sent by the virtualization operating system after creating the virtual server according to the command for creating a virtual server sent by the virtualization management platform device.

The frame number generating module 88 is configured to generate the virtual frame number corresponding to the identifier of the created virtual server.

The frame number sending module 89 is configured to send the virtual frame number generated by the frame number generating module 88 to the virtualization operating system so that the virtualization operating system generates the virtual slot number corresponding to the identifier of the created virtual server according to the virtual frame number.

According to the virtualization management platform device, each virtual server on a board may acquire a different virtual frame number and a different virtual slot number, so as to simplify the complicated procedure for acquiring a physical frame number and slot number. In addition, a frame and slot number service is involved in an application in an ATCA/ATAE frame management mode. For example, when the control plane IP address and services such as alarm and fault maintenance are migrated to the virtualization platform, virtual frame and slot numbers do not need to be modified. In addition, virtual frame and slot numbers are generated for the virtual servers on the board as required. In this way, applications that are based on the ATCA/ATAE frame management mode are transparently migrated to the virtualization platform.

It should be understood by those skilled in the art that the accompanying drawings are merely schematic diagrams of a preferable embodiment, and modules or processes in the accompanying drawings are not necessarily required in implementing the present invention.

Those skilled in the art should understand that the modules in the apparatuses provided in the embodiments may be arranged in the apparatuses in a distributed manner according to the description of the embodiments, or may be arranged in one or more apparatuses which are different from those described in the embodiments. The modules in the embodiments may be combined into one module, or split into multiple submodules.

For the specific procedures where the relevant apparatus in this embodiment executes the method according to the present invention, reference may be made to the relevant description in the embodiments for the method according to the present invention. They are not described herein.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they can still make modifications to the technical solutions described in the foregoing embodiments, or make equivalent substitutions to some technical features thereof, without departing from the spirit and scope of the technical solutions of the embodiments of the present invention.

What is claimed is:

1. A method for acquiring a virtual frame number and a virtual slot number at a virtualization platform, comprising:
receiving, by a virtualization operating system, a command for creating a virtual server sent from a virtualization management platform;
in response to the command for creating a virtual server, creating, by the virtualization operating system, a virtual server on a board;
after creating the virtual server, sending, by the virtualization operating system, a frame number request message carrying an identifier of the virtual server to the virtualization management platform;
receiving, by the virtualization operating system, a virtual frame number corresponding to the identifier of the virtual server sent from the virtualization management platform; and
obtaining, by the virtualization operating system, a virtual slot number corresponding to the identifier of the virtual server according to the virtual frame number.

2. The method according to claim 1, further comprising:
receiving, by the virtualization operating system, a request message for acquiring a virtual frame number and a virtual slot number that is sent by the virtual server and carries the identifier of the virtual server, wherein the identifier of the virtual server is unique; and
sending, by the virtualization operating system, the virtual frame number and the virtual slot number to the virtual server.

3. The method according to claim 2, further comprising:
after obtaining the virtual slot number, saving, by the virtualization operating system, the virtual frame number and the virtual slot number to a table entry in a configuration file, wherein the table entry corresponds to the identifier of the virtual server; and
after receiving the request message for acquiring a virtual frame number and a virtual slot number, searching, by the virtualization operating system, the configuration file according to the identifier of the virtual server to acquire the virtual frame number and virtual slot number.

4. The method according to claim 3, further comprising:
receiving, by the virtualization operating system, a command for deleting the virtual server which carries the identifier of the virtual server from the virtualization management platform;
in response to the command for deleting the virtual server, deleting, by the virtualization operating system, the virtual server according to the identifier of the virtual server; and
deleting, by the virtualization operating system, the table entry corresponding to the identifier of the virtual server from the configuration file.

5. The method according to claim 4, further comprising:
reclaiming, by the virtualization operating system, the deleted virtual frame number and the virtual slot number.

6. The method according to claim 1, wherein the obtaining the virtual slot number comprises:
determining, by the virtual operating system, that there is a reclaimed virtual slot number corresponding to the identifier of the virtual server; and
allocating, by the virtualization operating system, the reclaimed virtual slot number to the virtual server.

7. A method for acquiring a virtual frame number and a virtual slot number at a virtualization platform, comprising:
sending, by a virtualization management platform, a command for creating a virtual server on a board to a virtualization operating system;
receiving, by the virtualization management platform, a response to the command for creating a virtual server from the virtualization operating system;
obtaining, by the virtualization management platform, a virtual frame number and a virtual slot number which are corresponding to an identifier of the virtual server created by the virtualization operating system;
receiving, by the virtualization management platform, a request message for acquiring a virtual frame number and a virtual slot number that carries the identifier of the virtual server; and
sending, by the virtualization management platform, the virtual frame number and virtual slot number to the virtual server via the virtualization operating system.

8. The method according to claim 7, further comprising:
sending, by the virtualization management platform, a command for deleting a virtual server that carries the identifier of the virtual server to the virtualization operating system to instruct the virtualization operating system to delete the virtual server corresponding to the identifier; and
deleting, by the virtualization management platform, the virtual frame number and virtual slot number corresponding to the identifier of the virtual server.

9. The method according to claim 8, further comprising:
reclaiming the virtual frame number and virtual slot number corresponding to the identifier of the virtual server.

10. The method according to claim 9, wherein the obtaining the virtual frame number and the virtual slot number comprises:
determining, by the virtualization management platform, that a reclaimed virtual frame number and virtual slot number are available; and
allocating, by the virtualization management platform, the reclaimed virtual frame number and virtual slot number to the virtual server.

11. A non-transitory computer readable medium storing instructions for controlling a device to acquire a virtual frame number and a virtual slot number at a virtualization platform, the instructions comprising:
receiving a command for creating a virtual server sent from a virtualization management platform;
in response to the command for creating a virtual server, creating a virtual server on a board;
after creating the virtual server, sending a frame number request message carrying an identifier of the virtual server to the virtualization management platform;
receiving a virtual frame number corresponding to the identifier of the virtual server sent from the virtualization management platform; and
obtaining a virtual slot number corresponding to the identifier of the virtual server according to the virtual frame number.

12. The non-transitory computer readable medium according to claim 11, further comprising instructions to:
receive a request message for acquiring a virtual frame number and a virtual slot number that is sent by the virtual server and carries the identifier of the virtual server, wherein the identifier of the virtual server is unique; and
send the virtual frame number and the virtual slot number to the virtual server.

13. The non-transitory computer readable medium according to claim 12, further comprising instructions to:
after obtaining the virtual slot number, save the virtual frame number and the virtual slot number to a table entry in a configuration file, wherein the table entry corresponds to the identifier of the virtual server; and
after receiving the request message for acquiring a virtual frame number and a virtual slot number, search the configuration file according to the identifier of the virtual server to acquire the virtual frame number and virtual slot number.

14. The non-transitory computer readable medium according to claim 13, further comprising instructions to:
receive a command for deleting the virtual server which carries the identifier of the virtual server from the virtualization management platform;
in response to the command for deleting the virtual server, delete the virtual server according to the identifier of the virtual server; and
delete the table entry corresponding to the identifier of the virtual server from the configuration file.

15. The method according to claim 14, further comprising instructions to:
reclaim the deleted virtual frame number and the virtual slot number.

16. The method according to claim 11, wherein the obtaining the virtual slot number comprises:
determining that there is a reclaimed virtual slot number corresponding to the identifier of the virtual server; and
allocating the reclaimed virtual slot number to the virtual server.

17. A non-transitory computer readable medium storing instructions for controlling a device to acquire a virtual frame number and a virtual slot number at a virtualization platform, the instructions comprising:
sending a command for creating a virtual server on a board to a virtualization operating system;
receiving a response to the command for creating a virtual server from the virtualization operating system;
obtaining a virtual frame number and a virtual slot number which are corresponding to an identifier of the virtual server created by the virtualization operating system;
receiving a request message for acquiring a virtual frame number and a virtual slot number that carries the identifier of the virtual server; and
sending the virtual frame number and virtual slot number to the virtual server via the virtualization operating system.

18. The non-transitory computer readable medium according to claim 17, further comprising instructions to:
send a command for deleting a virtual server that carries the identifier of the virtual server to the virtualization operating system to instruct the virtualization operating system to delete the virtual server corresponding to the identifier; and
delete the virtual frame number and virtual slot number corresponding to the identifier of the virtual server.

19. The non-transitory computer readable medium according to claim 18, further comprising instructions to:
reclaim the virtual frame number and virtual slot number corresponding to the identifier of the virtual server.

20. The non-transitory computer readable medium according to claim 19, wherein the obtaining the virtual frame number and the virtual slot number comprises:
determining that a reclaimed virtual frame number and virtual slot number are available; and
allocating the reclaimed virtual frame number and virtual slot number to the virtual server.
